(19) United States
(12) Patent Application Publication
(10) Pub. No.: US 2005/0170980 A1
(43) Pub. Date: Aug. 4, 2005

(54) ER cleaning composition and method

(75) Inventors: Hsin-Hsien Lu, Hsinchu City (TW); Han-Hsin Kuo, Tainan City (TW); Ying-Ho Chen, Taipei (TW); Syum-Ming Jang, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/769,245

(22) Filed: Jan. 30, 2004

(51) Int. Cl. C11D 1/00

(52) U.S. Cl. 510/175

(57) ABSTRACT

A method for the cleaning of wafers typically during a chemical mechanical polishing (CMP) process. The method includes polishing a material layer on a wafer in sequential polishing steps, rinsing the wafer using a novel surfactant composition solution after at least one of the polishing steps and rinsing of the wafer using deionized water, respectively. The surfactant composition solution imparts a generally hydrophilic character to a hydrophobic material layer such as a high-k dielectric layer on the wafer. Consequently, the layer is rendered amenable to cleaning by deionized water, thereby significantly enhancing the removal of particles from the layer and reducing the number of defects related to the CMP process.

### FIELD OF THE INVENTION

The present invention relates to CMP cleaners for cleaning semiconductor wafers after chemical mechanical polishing (CMP) More particularly, the present invention relates to a novel wafer cleaning composition and method which is particularly effective in the post-CMP cleaning of wafers on which is deposited a hydrophobic low-k dielectric layer.

### BACKGROUND OF THE INVENTION

In the fabrication of semiconductor devices from a silicon wafer, a variety of semiconductor processing equipment and tools are utilized. One of these processing tools is used for polishing thin, flat semiconductor wafers to obtain a planarized surface. A planarized surface is highly desirable on a shadow trench isolation (STI) layer, inter-layer dielectric (ILD) or on an inter-metal dielectric (IMD) layer, which are frequently used in memory devices. The planarization process is important since it enables the subsequent use of a high-resolution lithographic process to fabricate the next-level circuit. The accuracy of a high resolution lithographic process can be achieved only when the process is carried out on a substantially flat surface. The planarization process is therefore an important processing step in the fabrication of semiconductor devices.

A global planarization process can be carried out by a technique known as chemical mechanical polishing, or CMP. The process has been widely used on ILD or IMD layers in fabricating modern semiconductor devices. A CMP process is performed by using a rotating platen in combination with a pneumatically-actuated polishing head. The process is used primarily for polishing the front surface or the device surface of a semiconductor wafer for achieving planarization and for preparation of the next level processing. A wafer is frequently planarized one or more times during a fabrication process in order for the top surface of the wafer to be as flat as possible. A wafer can be polished in a CMP apparatus by being placed on a carrier and pressed face down on a polishing pad covered with a slurry of colloidal silica or aluminum.

A polishing pad used on a rotating platen is typically constructed in two layers overlying a platen, with a resilient layer as an outer layer of the pad. The layers are typically made of a polymeric material such as polyurethane and may include a filler for controlling the dimensional stability of the layers. A polishing pad is typically made several times the diameter of a wafer in a conventional rotary CMP, while the wafer is kept off-center on the pad in order to prevent polishing of a non-planar surface onto the wafer. The wafer itself is also rotated during the polishing process to prevent polishing of a tapered profile onto the wafer surface. The axis of rotation of the wafer and the axis of rotation of the pad are deliberately not collinear; however, the two axes must be parallel. It is known that uniformity in wafer polishing by a CMP process is a function of pressure, velocity and concentration of the slurry used.

A CMP process is frequently used in the planarization of an ILD or IMD layer on a semiconductor device. Such layers are typically formed of a dielectric material. A most popular dielectric material for such usage is silicon oxide. In a process for polishing a dielectric layer, the goal is to remove typography and yet maintain good uniformity across the entire wafer. The amount of the dielectric material removed is normally between about 5000 A and about 10,000 A. The uniformity requirement for ILD or IMD polishing is very stringent since non-uniform dielectric films lead to poor lithography and resulting window-etching or plug-formation difficulties. The CMP process has also been applied to polishing metals, for instance, in tungsten plug formation and in embedded structures. A metal polishing process involves a polishing chemistry that is significantly different than that required for oxide polishing.

Important components used in CMP processes include an automated rotating polishing platen and a wafer holder, which both exert a pressure on the wafer and rotate the wafer independently of the platen. The polishing or removal of surface layers is accomplished by a polishing slurry consisting mainly of colloidal silica suspended in deionixed water or KOH solution. The slurry is frequently fed by an automatic slurry feeding system in order to ensure uniform wetting of the polishing pad and proper delivery and recovery of the slurry. For a high-volume wafer fabrication process, automated wafer loading/unloading and a cassette handler are also included in a CMP apparatus.

As the name implies, a CMP process executes a microscopic action of polishing by both chemical and mechanical means. While the exact mechanism for material removal of an oxide layer is not known, it is hypothesized that the surface layer of silicon oxide is removed by a series of chemical reactions which involve the formation of hydrogen bonds with the oxide surface of both the wafer and the slurry particles in a hydrogenation reaction; the formation of hydrogen bonds between the wafer and the slurry; the formation of molecular bonds between the wafer and the slurry; and finally, the breaking of the oxide bond with the wafer or the slurry surface when the slurry particle moves away from the wafer surface. It is generally recognized that the CMP polishing process is not a mechanical abrasion process of slurry against a wafer surface.

While the CMP process provides a number of advantages over the traditional mechanical abrasion type polishing process, a serious drawback for the CMP process is the difficulty in controlling polishing rates at different locations on a wafer surface. Since the polishing rate applied to a wafer surface is generally proportional to the relative rotational velocity of the polishing pad, the polishing rate at a specific point on the wafer surface depends on the distance from the axis of rotation. In other words, the polishing rate obtained at the edge portion of the wafer that is closest to the rotational axis of the polishing pad is less than the polishing rate obtained at the opposite edge of the wafer. Even though this is compensated for by rotating the wafer surface during the polishing process such that a uniform average polishing rate can be obtained, the wafer surface, in general, is exposed to a variable polishing rate during the CMP process.

Recently, a chemical mechanical polishing method has been developed in which the polishing pad is not moved in a rotational manner but instead, in a linear manner. It is therefore named as a linear chemical mechanical polishing process, in which a polishing pad is moved in a linear manner in relation to a rotating wafer surface. The linear polishing method affords a more uniform polishing rate across a wafer surface throughout a planarization process for the removal of a film layer from the surface of a wafer. One added advantage of the linear CMP system is the simpler construction of the apparatus, and this not only reduces the cost of the apparatus but also reduces the floor space required in a clean room environment.

A typical conventional CMP apparatus 90 is shown in FIG. 1 and includes a base 100; polishing pads 210a, 210b, and 210c provided on the base 100; a head clean load/unload (HCLU) station 360 which includes a load cup 300 for the loading and unloading of wafers (not shown) onto and from, respectively, the polishing pads; and a head rotation unit 400 having multiple polishing pads 410a, 410b, 410c and 410d for holding and fixedly rotating the wafers on the polishing pads.

The three polishing pads 210a, 210b and 210c facilitate simultaneous processing of multiple wafers in a short time. Each of the polishing pads is mounted on a rotatable carousel (not shown). Pad conditioners 211a, 211b and 211c are typically provided on the base 100 and can be swept over the respective polishing pads for conditioning of the polishing pads. Slurry supply arms 212a, 212b and 212c are further provided on the base 100 for supplying slurry to the surfaces of the respective polishing pads.

The polishing heads 410a, 410b, 410c and 410d of the head rotation unit 400 are mounted on respective rotation shafts 420a, 420b, 420c, and 420d which are rotated by a driving mechanism (not shown) inside the frame 401 of the head rotation unit 400. The polishing heads hold respective wafers (not shown) and press the wafers against the top surfaces of the respective polishing pads 210a, 210b and 210c. In this manner, material layers are removed from the respective wafers. The head rotation unit 400 is supported on the base 100 by a rotary bearing 402 during the CMP process.

The load cup 300 is detailed in FIG. 1 and includes a pedestal support column 312 that supports a circular pedestal 310 on which the wafers are placed for loading of the wafers onto the polishing pads 210a, 210b and 210c, and unloading of the wafers from the polishing pads. A pedestal film 313 is typically provided on the upper surface of the pedestal 310 for contacting the patterned surface (the surface on which IC devices are fabricated) of each wafer. Fluid openings 314 extend through the pedestal 310 and pedestal film 313. The bottom surfaces of the polishing heads 410a, 410b, 410c and 410d and the top surface of the pedestal film 313 are washed at the load cup 300 by the ejection of washing fluid through the fluid openings 314.

In typical operation of the CMP apparatus 90, each wafer is mounted on a polishing head 410a, 410b, 410c or 410d and sequentially polished against the polishing pads 210a, 210b and 210c, respectively. Each polishing pad represents a separate polishing step in which a different material on the wafer may be polished. For example, the first polishing step on the first polishing pad 210a may be a copper polishing step; the second polishing step on the second polishing pad 210b, a tantalum nitride (TaN) polishing step; and the third polishing step on the third polishing pad 210c, an oxide polishing step. After the polishing sequence is completed, the wafer is subjected to post-CMP cleaning to remove slurry and other particles from the wafer. In addition to the post-CMP cleaning step, the wafer may be rinsed with de-ionized water (DIW) between polishing steps.

An important challenge in CMP is to produce a clean substrate surface following polishing. Therefore, a primary concern with the use of CMP is the efficient and complete removal of the polishing slurry and other polishing residues and particulates following polishing in order to prevent introduction of defects into the polished product. Ideally, post-CMP cleaning should remove all polishing slurry, polishing residues and particulates in a quick and repeatable fashion without introducing additional defects or damage to the substrate surface. Cleaning procedures following CMP typically include use of a DI (deionized) water rinse, megasonic cleaning and a scrub with a soft rotating brush to remove slurry residue from the surface of the semiconductor substrate. However, use of a DI water rinse alone causes the brush to become loaded with particles, which tend to contaminate other wafers. Accordingly, ammonium hydroxide, hydrogen fluoride, hydrogen peroxide and other chemicals may be used in conjunction with water to clean the wafers.

One of the drawbacks of using deionized water to rinse a low-k dielectric film on a wafer between CMP polishing steps is due to the fact that the carbon content of a low-k dielectric film is higher than that of a non low-k dielectric film. This imparts a hydrophobic characteristic to the low-k dielectric film. Consequently, the rinsing deionized water is repelled by the dielectric film surface, rendering more difficult the removal of particulate contaminants from the surface of the film. Therefore, the post-CMP defect count is directly related to the dielectric constant of dielectric films.

Moreover, brush fibers of soft brushes used in the post-CMP cleaning of high-k dielectric films tend to become dislodged and adhere to the surface of the film. These fibers are difficult to remove using deionized water alone. Additionally, BTA (benzotriazole) is frequently used in copper CMP polishing applications to prevent copper corrosion. Because BTA solubility in water is low, BTA residues which remain on the wafer are common after the rinsing or cleaning process.

An object of the present invention is to provide a new and improved method for cleaning wafers.

Another object of the present invention is to provide a method which is suitable for cleaning wafers during or after a CMP process.

Still another object of the present invention is to provide a method which is suitable for cleaning wafers having a low-k dielectric layer thereon.

Yet another object of the present invention is to provide a method which is particularly effective in cleaning hydrophobic layers on a wafer.

A still further object of the present invention is to provide a method which is suitable for cleaning wafers having a metal layer thereon.

Yet another object of the present invention is to provide a method which is effective in rendering a hydrophobic surface hydrophilic to enhance the cleaning of particles from the surface.

A still further object of the present invention is to provide a surfactant composition for the cleaning of particles from a layer on a wafer.

Another object of the present invention is to provide a wafer cleaning method which may include the cleaning of a wafer with a surfactant composition solution after a polishing step or steps during a CMP process.

### SUMMARY OF THE INVENTION

In accordance with these and other objects and advantages, the present invention is directed to a new and improved method for the cleaning of wafers typically during a chemical mechanical polishing (CMP) process. The method includes polishing a material layer on a wafer in sequential polishing steps, rinsing the wafer using a novel surfactant composition solution after at least one of the polishing steps and rinsing of the wafer using deionized water, respectively. The surfactant composition solution imparts a generally hydrophilic character to a hydrophobic material layer such as a low-k dielectric layer on the wafer. Consequently, the layer is rendered amenable to cleaning by deionized water, thereby significantly enhancing the removal of particles from the layer and reducing the number of defects related to the CMP process.

The method of the present invention includes the step of applying a surfactant composition solution at least once to a layer on a wafer, typically after the layer is polished at one or more of the polishing steps in a CMP polishing sequence. Preferably, the surfactant composition solution is applied to the layer after the last polishing step in the polishing sequence. Most preferably, the surfactant composition solution is applied to the layer after each polishing step in the polishing sequence.

In accordance with the present invention, the surfactant composition solution is an aqueous alcohol solution. Preferably, the alcohol is a C₄-C₁₂ alcohol, and most preferably, a C₁₀-C₁₂ alcohol. In one embodiment, the surfactant composition soluton includes from typically about 0.01% to typically about 1% by volume alcohol in water. In another embodiment, the surfactant composition solution includes about an aqueous mixture of a C4-C10 alcohol and ethylene oxide in a 1:4 volume ratio.

### BRIEF DESCRIPTION OF THE DRAWINGS

The invention will now be described, by way of example, with reference to the accompanying drawings, in which:

FIG. 1 is a perspective view of a typical conventional chemical mechanical polishing apparatus for the simultaneous polishing of multiple wafers;

FIG. 1A is a top perspective view, partially in section, of a conventional pedestal assembly of the CMP apparatus of FIG. 1;

FIG. 2 is a flow diagram illustrating sequential process steps according to a typical wafer cleaning method of the present invention; and

FIG. 3 is a top view of a rotary-type CMP apparatus, in implementation of the present invention.

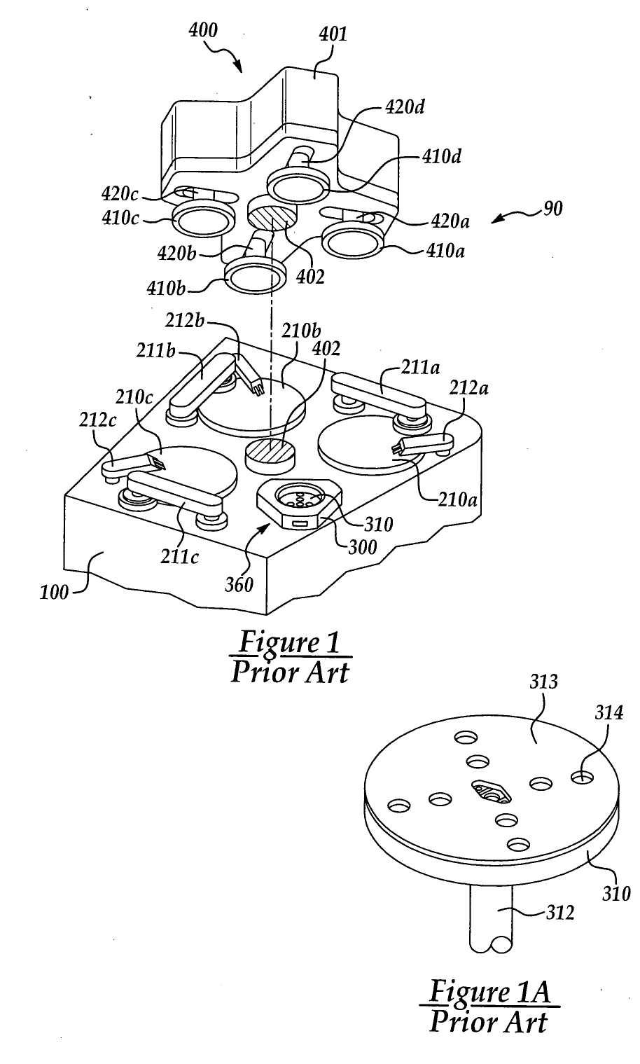

### DETAILED DESCRIPTION OF THE INVENTION

The present invention contemplates a new and improved method for the cleaning of wafers and is particularly applicable to the cleaning of wafers during a chemical mechanical polishing (CMP) process. The method includes polishing a material layer or layers, particularly a metal layer or a hydrophobic, low-k dielectric layer or layers, on a wafer at sequential polishing steps in a polishing sequence. After at least one of the polishing steps, a novel surfactant composition solution is applied to the polished layer in a surfactant rinse step, followed typically by rinsing of the layer using high-pressure deionized water in a water rinse step.

Preferably, the surfactant composition solution is applied to a polished layer after the last polishing step in the polishing sequence. Most preferably, the surfactant is applied to a polished layer after each polishing step in the polishing sequence. The surfactant composition solution imparts a generally hydrophilic character to the layer, rendering the layer amenable to cleaning by deionized water. This significantly enhances the removal of particles from the layer and substantially reduces the number of CMP-induced defects. Furthermore, the surfactant composition solution stabilizes the polishing rate by cleaning the surface of the polishing pad on the CMP apparatus.

At each surfactant rinse step, the surfactant composition solution is dispensed onto the polished layer on the wafer at a flow rate of typically about 200˜500 ml/min as the polishing head rotates the wafer against the polishing platen on the CMP apparatus. During each surfactant rinse step, the polishing platen rotational speed is typically about 66˜150 rpm, and the polishing head/wafer rotational speed is typically about 10˜150 rpm. The down force of the wafer against the polishing platen is typically about 0˜1.5 psi. Each surfactant rinse step is carried out for a duration of typically about 10˜30 seconds. In the water rinse step which follows a polishing step and surfactant rinse step, deionized water is applied to the surfactant-treated layer for a duration of typically about 5˜10 seconds.

Each of the polishing steps in the polishing sequence may be broken down into two or more polishing sub-steps. In that case, each polishing sub-step is typically followed by a surfactant rinse step. After the second or last polishing sub-step of each polishing step is completed, the surfactant rinse step is followed by a water rinse step. This removes CMP-induced particulate contaminants from the wafer prior to commencement of the next polishing step in the polishing sequence.

The surfactant composition solution of the present invention may be an aqueous alcohol solution. Preferably, the alcohol is a C₄-C₁₂ alcohol. Most preferably, the alcohol is a C₁₀-C₁₂ alcohol, having the formula CₙH₂ₙ₊₁OH, where n=10, 11 or 12. In a preferred embodiment, the alcohol is octanol (C₂₀H₂₁OH)

The surfactant composition solution of the present invention typically has a concentration of less than 1% alcohol. In one embodiment, the surfactant composition solution includes from typically about 0.01% to typically about 1% alcohol, by volume. In another embodiment, the surfactant composition solution includes an aqueous mixture of 1% C₄-C₁₂ alcohol and ethylene oxide (C₂H₄O) in a 1:4 volume ratio. Preferably, the alcohol is present in the aqueous solution at a concentration which is greater than the critical micelle concentration (CMC). The surfactant composition solution has a pH of preferably about 6˜7, or neutral.

Referring initially to FIG. 3, wherein a rotary CMP apparatus 10 in implementation of the present invention is shown. The CMP apparatus 10 typically includes a base 12 on which is provided a first polishing platen 14a, a second polishing platen 14b and a third polishing platen 14c. A head rotation unit 18 is provided above the base 12. A first polishing head 20a, a second polishing head 20b, a third polishing head 20c and a fourth polishing head 20d are provided on the head rotation unit 18. A load cup 16 is provided on the base 12 for the loading of wafers onto and from the polishing heads 20a-20d. A CLC controller 22 is operably connected to the polishing platens 14a-14c and the polishing heads 20a-20d to control the polish time as well as the polish down-pressure and other variables of each polishing step. It is understood that the method of the present invention may be equally adaptable to CMP apparatus of alternative design, including but not limited to linear-type CMP apparatus.

The wafer cleaning method of the present invention is carried out typically in conjunction with a CMP polishing sequence. For example, the polishing steps of the polishing sequence may be implemented to sequentially polish a copper layer; a tantalum nitride (TaN), titanium nitride (TiN) or aluminum layer; and an oxide, nitride or low-k dielectric layer on each of multiple wafers 26 in a wafer lot 24, shown in FIG. 3. Accordingly, a typical CMP polishing sequence includes at least one copper polishing step; at least one TaN polishing step; and at least one oxide polishing step. For purposes of discussion and not limitation, each copper polishing step, TaN polishing step and oxide polishing step of the present invention is divided into first and second polishing sub-steps, as hereinafter described. Each polishing step may be carried out according to process parameters which are known by those skilled in the art, depending on the particular layer being polished in the polishing sequence.

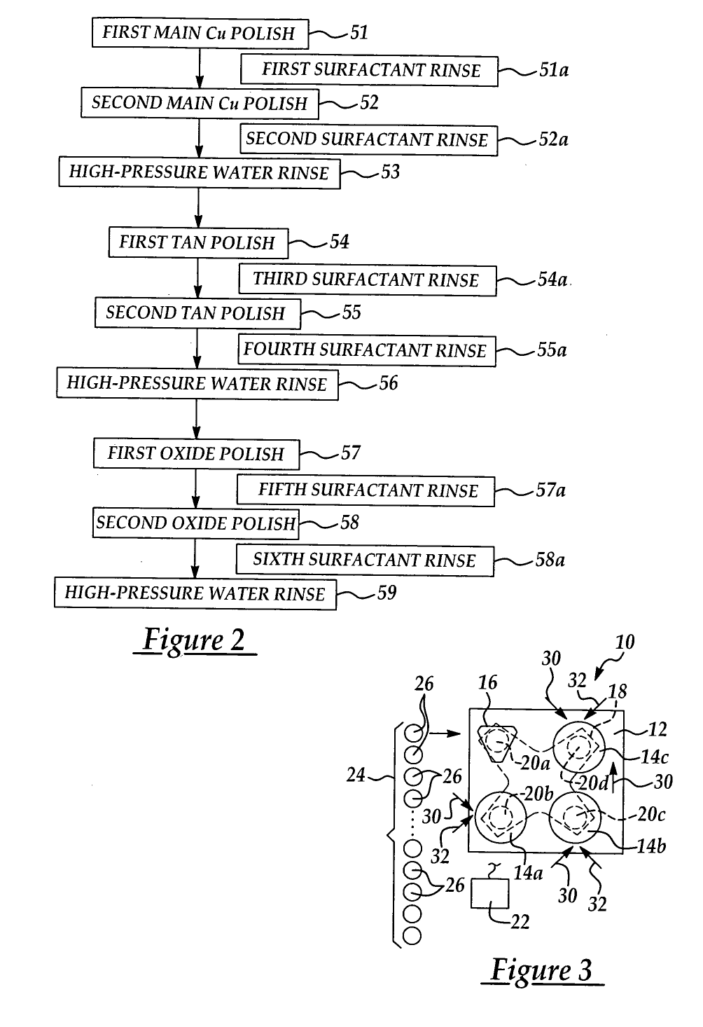

Referring next to FIGS. 2 and 3, a polishing sequence according to the wafer cleaning method of the present invention is begun by sequentially loading each wafer 26 in the wafer lot 24 onto the load cup 16. From the load cup 16, each wafer 26 is individually and sequentially loaded onto one of the polishing heads 20a-20d of the head rotation assembly 18. As indicated in step S1 of FIG. 2, each wafer 26 is initially polished against the first polishing platen 14a in a first copper polishing sub-step.

After the first copper polishing sub-step S1, the wafer 26 is subjected to a first surfactant rinse, as indicated in step S1a of FIG. 2. Accordingly, the surfactant composition solution 30 is applied to the wafer 26 at a flow rate of typically about 200˜500 ml/min. As the solution 30 is applied to the wafer 26, the polishing head rotates the wafer 26 against the first polishing platen 14a at a polishing head/wafer rotational speed of typically about 10˜150 rpm and a polishing platen rotational speed of typically about 66˜150 rpm, and at a down force of typically about 0˜1.5 psi, for a duration of typically about 10˜30 seconds.

After the first surfactant rinse S1a, the wafer 26 is subjected to a second copper polishing sub-step S2, to complete the two-step copper polishing sequence. This second copper polishing sub-step S2 is followed by a second surfactant rinse step S2a, in which additional surfactant composition solution 30 is applied to the wafer 26. Next, the polished copper layer (not shown) on the wafer 26 is subjected to a high-pressure water rinse step S3, in which de-ionized water 32 is sprayed against the layer for a duration of typically about 5˜10 seconds. The first polishing sub-step S1, the first surfactant rinse step S1a, the second polishing sub-step S2, the second surfactant rinse step S2a and the high-pressure water rinse step S3 are typically carried out while the wafer 26 remains at the first polishing platen 14a.

After completion of the high-pressure water rinse step S3, the wafer 26 is transferred from the first polishing platen 14a to the second polishing platen 14b. A TaN layer (not shown) on the wafer 26 is then polished by rotation of the layer against the second polishing platen 14b in a first TaN polishing sub-step S4. This is followed by subjecting the layer to a third surfactant rinse step S4a, a second TaN polishing sub-step S5, a fourth surfactant rinse step S5a and a high-pressure water rinse step S6, respectively. The third surfactant rinse step S4a, fourth surfactant rinse step S5a and high-pressure water rinse step S6 may be carried out according to the same or different process paramaters as those heretofore described with respect to the surfactant rinse steps and water rinse step of steps S1-S3.

The wafer 26 is next transferred from the second polishing platen 14b to the third polishing platen 14c. An oxide layer (not shown) on the wafer 26 is then polished by rotation of the oxide layer against the third polishing platen 14c in a first oxide polishing sub-step S7. This is followed by subjecting the oxide layer to a fifth surfactant rinse step S7a, by the application of surfactant composition solution 30 to the layer; a second oxide polish sub-step S8; a sixth surfactant rinse step S8a; and a high-pressure water rinse step S9, by the application of deionized water 32 to the layer, respectively. After the high-pressure water rinse step S9 is completed, the wafer 26 is transferred from the CMP apparatus 10 and may be subjected to additional post-CMP cleaning, such as using megasonic and brush cleaning, for example, as is known by those skilled in the art.

While the preferred embodiments of the invention have been described above, it will be recognized and understood that various modifications can be made in the invention and the appended claims are intended to cover all such modifications which may fall within the spirit and scope of the invention.

1. A method of cleaning a wafer, comprising the steps of:
providing a surfactant composition solution;
subjecting said wafer to a plurality of polishing steps;
applying said surfactant composition solution to said wafer after at least one of said plurality of polishing steps; and
rinsing said wafer.

2. The method of claim 1 wherein said applying said surfactant composition to said wafer comprises applying said surfactant composition to said wafer after completion of said plurality of polishing steps.

3. The method of claim 1 wherein said surfactant solution comprises an aqueous alcohol solution.

4. The method of claim 3 wherein said applying said surfactant composition to said wafer comprises applying said surfactant composition to said wafer after completion of said plurality of polishing steps.

5. The method of claim 1 wherein said rinsing said wafer comprises providing deionized water and rinsing said wafer using said deionized water.

6. The method of claim 5 wherein said applying said surfactant composition to said wafer comprises applying said surfactant composition to said wafer after completion of said plurality of polishing steps.

7. The method of claim 5 wherein said surfactant solution comprises an aqueous alcohol solution.

8. The method of claim 3 wherein said aqueous alcohol solution comprises from about 0.01% to about 1% alcohol by volume.

9. The method of claim 8 wherein said applying said surfactant composition to said wafer comprises applying said surfactant composition to said wafer after completion of said plurality of polishing steps.

10. The method of claim 8 wherein said rinsing said wafer comprises providing deionized water and rinsing said wafer using said deionized water.

11. The method of claim 8 wherein said alcohol comprises octanol.

12. The method of claim 8 further comprising ethylene oxide in said aqueous alcohol solution.

13. A method of cleaning a wafer, comprising the steps of:
providing a surfactant composition solution;
subjecting said wafer to a plurality of polishing steps;
applying said surfactant composition solution to said wafer after each of said plurality of polishing steps; and
rinsing said wafer.

14. The method of claim 13 wherein said surfactant solution comprises an aqueous alcohol solution.

15. The method of claim 14 wherein said aqueous alcohol solution comprises from about 0.01% to about 1% alcohol by volume.

16. The method of claim 15 further comprising ethylene oxide in said aqueous alcohol solution.

17. A composition solution for rendering a surface on a wafer hydrophilic to facilitate rinsing of the wafer with water, comprising:
an aqueous solution comprising less than about 1% alcohol.

18. The composition solution of claim 17 wherein said alcohol is an alcohol having the formula CₙH₂ₙ₋₁OH, where n is any one of the integers 4-12.

19. The composition solution of claim 17 wherein said alcohol is octanol.

20. The composition solution of claim 17 wherein said aqueous alcohol solution comprises from about 0.01% to about 1% alcohol by volume and ethylene oxide.
